(19) United States
(12) Patent Application Publication
(10) Pub. No.: US 2013/0171540 A1
(43) Pub. Date: Jul. 4, 2013

(54) BIMETAL CURRENT COLLECTING MEMBER AND FUEL CELL APPARATUS WITH THE SAME

(71) Applicants: Bon Seok Koo, Seoul (KR); Sung Han Kim, Seoul (KR); Eon Soo Lee, Gyeongsangbuk-do (KR)

(72) Inventors: Bon Seok Koo, Seoul (KR); Sung Han Kim, Seoul (KR); Eon Soo Lee, Gyeongsangbuk-do (KR)

(73) Assignee: SAMSUNG ELECTRO-MECHANICS CO., LTD., Gyunggi-do (KR)

(21) Appl. No.: 13/468,530

(22) Filed: May 10, 2012

(30) Foreign Application Priority Data
Dec. 28, 2011 (KR) 1020110144763

(51) Int. Cl. H01M 4/64; H01M 8/10; H01M 4/66; H01M 4/70; H01M 4/80

(52) U.S. Cl. 429/482; 429/517; 429/522

(57) ABSTRACT

Disclosed herein is a fuel cell apparatus including: a first electrode support having a tubular shape; an interconnector connected to one side of the first electrode support; an electrolyte membrane surrounding the interconnector and covering an outer surface of the first electrode support; a second electrode formed at the outer surface of the electrolyte membrane while being spaced apart from the interconnector; a first current collecting member surrounding an outer surface of the second electrode; and a second current collecting member engaged with an outer surface of the first current collecting member and having a bimetal structure.

### CROSS REFERENCE TO RELATED APPLICATION

This application claims the benefit of Korean Patent Application No. 10-2011-0144763, filed on Dec. 28, 2011, entitled “Bimetal Current Collecting Member and Fuel Cell Apparatus With The Same”, which is hereby incorporated by reference in its entirety into this application.

### BACKGROUND OF THE INVENTION

1. Technical Field

The present invention relates to a bimetal current collecting member and a fuel cell apparatus with the same.

2. Description of the Related Art

A solid oxide fuel cell (SOFC) is operated at a high temperature of 700 to 1000° C., by using a solid oxide having oxygen or hydrogen ion-conductivity as an electrolyte.

The solid oxide fuel cell has components made of solid, such that it may have a simple structure compared to other fuel cells, have no problems in loss, supplement and corrosion of the electrolyte, and facilitate supply of fuel through a direct internal reforming without a precious metal catalyst. Further, the solid oxide fuel cell discharges high-temperature gas, such that it may perform a combined heat and power generator using waste heat.

Due to these advantages, research into the solid oxide fuel cell has been actively conducted in developed countries such as the US, Japan, or the like, for the purpose of commercialization.

As described in Korean Patent Laid-Open Publication No. 2010-0007862 (laid-open published on Jan. 22, 2010), the solid oxide fuel cell in the prior art includes a dense electrolyte layer having high oxygen ion conductivity, and porous cathode and anode layers, which are positioned at both sides of the electrolyte layer. According to an operational principle, oxygen penetrates through the porous cathode to reach the electrolyte surface, and oxygen ions generated by the reduction reaction of oxygen move to the anode through the dense electrolyte and then react with hydrogen supplied to the porous anode, thereby generating water. In this case, electrons are generated in the anode and are consumed in the cathode. As a result, when two electrodes are connected to each other, electricity is generated.

In order to actually use the electricity generated by the operational principle, a predetermined level of voltage and current are required, such that the entire system is configured of a bundle or a stack in which several unit cells are connected to each other in series or in parallel using interconnects and current collector.

In order to collect electricity generated in each cell, the following methods have been used according to the prior art: \textcircled{1} wire winding method of winding a high conductive wire around a cell of an outer portion of an electrode, \textcircled{2} a method of forming an interconnector at an outer portion of a fuel cell using LaCrO₃ based ceramic interconnector material to connect between a current collector and a cell, \textcircled{3} and a method of using porous current collecting members, and the like.

First, the wire winding method is a method of collecting electricity by winding the high conductive wire around an outer portion of the electrode. In this method, the electricity is collected by a contact between the conductive wire and the electrode. In this method, since current collection efficiency may be increased, when a contact area between the electrode and the conductive wire is increased, it is advantageous to densely wind a thin wire.

However, in this case, since strength of the wire is deteriorated, hardness of the wire is reduced, a contact resistance is increased due to thermal expansion, and a length of the wire is also increased, at an operating temperature of the solid oxide fuel cell.

Second, the method of using an interconnector is a method formed using a pelt or a mesh between cells. In this method, in order to collect electricity generated from external electrode, such as a cathode and an anode, a current collector formed of a ceramic paste is applied to the external electrodes. However, the current collector formed of the ceramic paste has excellent durability, but has electrical conductivity lower than that of a metal, such that current collection efficiency is low.

Finally, in the method of using a porous current collecting member, since a porous current collecting member is formed of a metal having excellent oxidization-resistance and conductivity, a contact point between the porous current collecting member and the electrode is increased and a moving path of current is reduced as compared to the wire winding method, such that current to collecting resistance is reduced.

However, since the porous current collecting member is formed of the metal, a contact between the electrode and the current collecting member is reduced at a high operating temperature of the solid oxide fuel cell.

### SUMMARY OF THE INVENTION

The present invention has been made in an effort to provide a bimetal current collecting member capable of improving a contact between an electrode and a current collecting member even at a high operating temperature of a solid oxide fuel cell.

Further, the present invention has been made in an effort to provide a fuel cell apparatus with the bimetal current collecting member.

According to a preferred embodiment of the present invention, there is provided a bimetal current collecting member including: an inner metal plate engaged with the current collecting member surrounding an outer surface of a fuel cell; and an outer metal plate having a thermal expansion coefficient higher than that of the inner metal plate and provided on an outer surface of the inner metal plate.

The inner metal plate may have a polygonal cross section according to an appearance of current collecting member.

The current collecting member may be formed of a mesh or a pelt, and the inner metal plate may have a C-shaped cross section in which it surrounds the current collecting member.

The current collecting member may be a porous member formed of a metal foam or a metal fiber, and the inner metal plate may have a bent cross section in which it surrounds the current collecting member.

The inner metal plate may be formed of Cr based alloy or Ferritic stainless steel, and the outer metal plate may be formed of Austenitic stainless steel or Fe—Ni—Cr based alloy.

According to another preferred embodiment of the present invention, there is provided a fuel cell apparatus including: a first electrode support having a tubular shape; an interconnector connected to one side of the first electrode support; an electrolyte membrane surrounding the interconnector and covering an outer surface of the first electrode support; a second electrode formed at the outer surface of the electrolyte membrane while being spaced apart from the interconnector; a first current collecting member surrounding an outer surface of the second electrode; and a second current collecting member engaged with an outer surface of the first current collecting member and having a bimetal structure.

The first electrode support may be an anode support, and the second electrode may be a cathode, or the first electrode structure may be a cathode support, and the second electrode may be an anode.

The second current collecting member may include an inner metal plate engaged with an outer surface of the first current collecting member; and an outer metal plate having a thermal expansion coefficient higher than that of the inner metal plate and provided on the outer surface of the inner metal plate.

The inner metal plate and the outer metal plate may be bonded to each other by any one of cladding, welding and compressing methods.

The first current collecting member may be subjected to oxidation-resistance coating treatment in order to prevent oxidization.

### BRIEF DESCRIPTION OF THE DRAWINGS

FIG. 1 is a side view showing an anode support type fuel cell apparatus with a bimetal current collecting member according to a preferred embodiment of the present invention;

FIG. 2A is a cross-sectional view taken along line I-I′ of FIG. 1;

FIG. 2B is a cross-sectional view showing a cathode support type fuel cell apparatus with a bimetal current collecting member according to the preferred embodiment of the present invention;

FIG. 3 is a cross-sectional view showing a bimetal current collecting member according to the preferred embodiment of the present invention;

FIG. 4 is a side view showing an anode support type fuel cell apparatus with a bimetal current collecting member according to another preferred embodiment of the present invention;

FIG. 5A is a cross-sectional view taken along line II-II′ of FIG. 1;

FIG. 5B is a cross-sectional view showing a cathode support type fuel cell apparatus with a bimetal current collecting member according to another preferred embodiment of the present invention; and

FIG. 6 is a cross-sectional view showing a bimetal current collecting member according to another preferred embodiment of the present invention.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In the description, the terms “first”, “second”, and so on are used to distinguish one element from another element, and the elements are not defined by the above terms. In describing the present invention, a detailed description of related known functions or configurations will be omitted so as not to obscure the gist of the present invention.

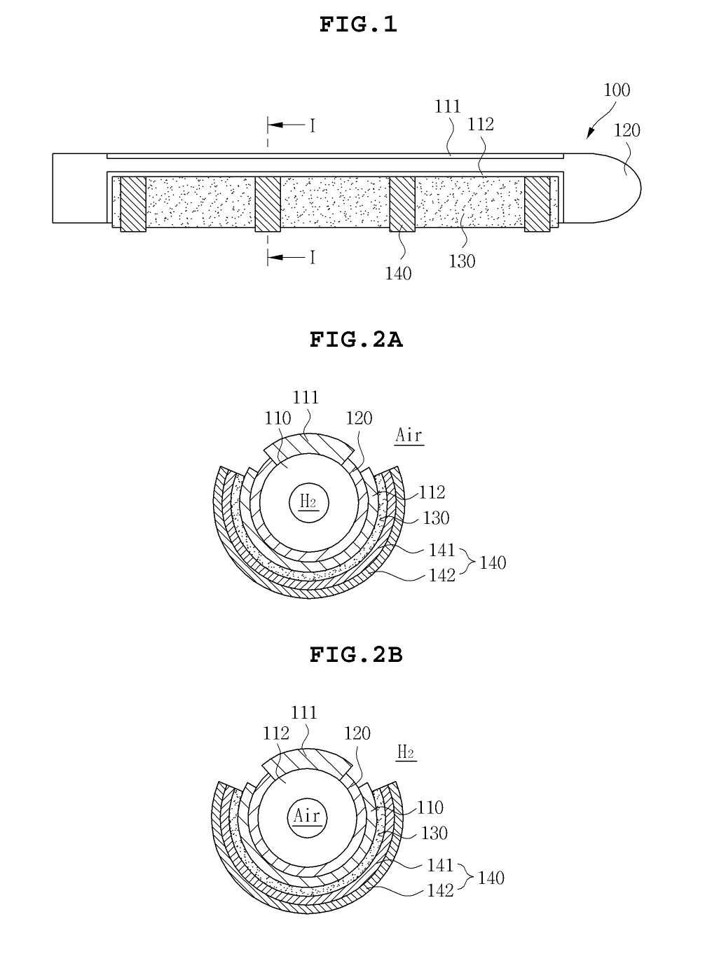

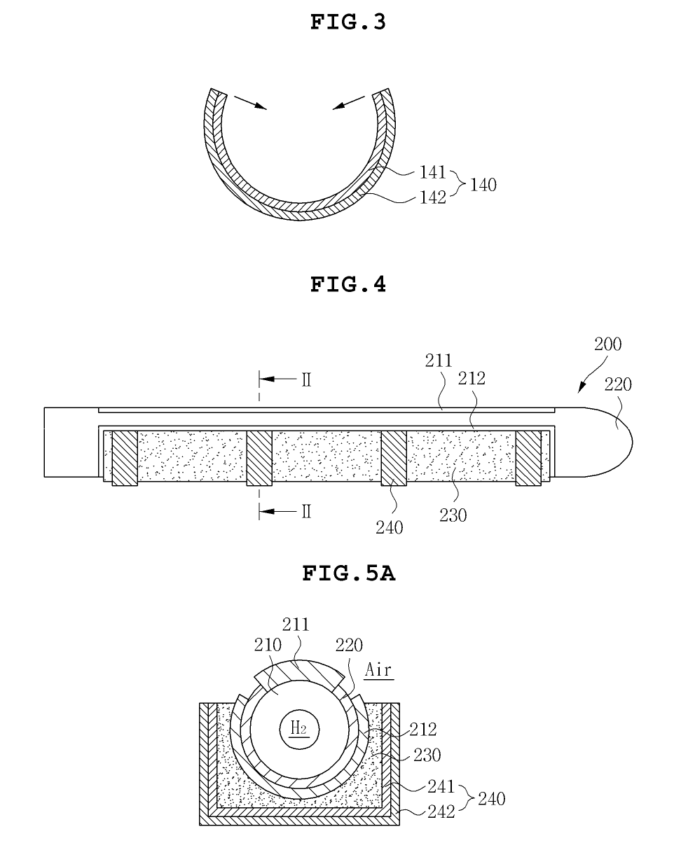

Hereinafter, preferred embodiments of the present invention will be described in detail with reference to the accompanying drawings. FIG. 1 is a side view showing an anode support type fuel cell apparatus with a bimetal current collecting member according to a preferred embodiment of the present invention. FIG. 2A is a cross-sectional view taken along line I-I′ of FIG. 1. FIG. 2B is a cross-sectional view showing a cathode support type fuel cell apparatus with a bimetal current collecting member according to the preferred embodiment of the present invention. FIG. 3 is a cross-sectional view showing a bimetal current collecting member according to the preferred embodiment of the present invention.

A fuel cell apparatus 100 with a bimetal current collecting member 140 according to a preferred embodiment of the present invention includes an anode support 110 having a tubular shape, an interconnector 111 connected at the anode support 110, an electrolyte membrane 120 surrounding the interconnector 111 and covering the outer surface of the anode support 110, a cathode 112 formed at the outer surface of the electrolyte membrane 120, a first current collecting member 130 covering the outer surface of the cathode 112, and a second current collecting member 140 surrounding the first current collecting member 130.

The anode support 110 supports the electrolyte membrane 120, the cathode 112, or the like, stacked at an outer peripheral surface thereof. Therefore, the anode support 110 may be relatively thicker than the electrolyte membrane 120 and the cathode 112 in order to secure supporting force, and may be formed by being subjected to an extruding process.

In addition, the anode support 110 having a tubular shape is supplied with a fuel (hydrogen) from a manifold to thereby generate a negative current through an electrode reaction. Here, the anode support 110 is formed using nickel oxide (NiO) and yttria stabilized zirconia (YSZ), where the nickel oxide is reduced to a metal nickel by hydrogen to have electronic conductivity and the yttria stabilized zirconia, being an oxide, has ion conductivity.

In this case, a weight ratio of the nickel oxide and the yttria stabilized zirconia forming the anode support 110 may be, for example, 50:50 to 40:60.

The interconnector 111 is connected to one side of the anode support 110 to transfer a negative current generated from the anode support 110 to the outside. Here, the interconnector 111 is a member for current collecting of the anode support 110, and thus it needs to have an electrical conductivity.

In this case, since the interconnector 111 is electrically connected with the anode support 110, a short occurs when being contacted with the cathode 112. Therefore, the interconnector 111 and the cathode 112 may be spaced apart from each other at a predetermined distance.

The electrolyte membrane 120 transferring an oxygen ion generated from the cathode 112 to the anode support 110 is formed so as to surround the interconnector 111 and cover an outer peripheral surface of the anode support 110. Here, the electrolyte membrane 120 may be formed by performing the coating by dry methods such as a plasma spray method, an electrochemical deposition method, a sputtering method, an ion beam method, an ion injection method, and the like, or wet methods such as a tape casting method, a spray coating method, a dip coating method, a screen printing method, a doctor blade method, and the like, and performing the sintering.

In this case, the electrolyte membrane 120 formed by using the yttria stabilized zirconia, scandium stabilized zirconia (ScSZ), GDC, LDC, and the like has low ion conductivity to thereby generate a small voltage drop due to resistance polarization. Therefore, the electrolyte membrane 120 may be formed as thinly as possible.

The cathode 112, supplied with an air (oxygen) from the outside to generate positive current through an electrode reaction, is formed at the outer surface of the electrolyte membrane 120, while being spaced apart from the interconnector 111. Here, the cathode 112 may be formed by coating lanthanum strontium manganite ((La_{0.84}Sr_{0.16})MnO₃), and the like, having a high electronic conductivity, using dry methods and wet methods, and then sintering it.

In the cathode 112, air (oxygen) is changed into oxygen ions by a catalyst action of the lanthanum strontium manganite, and the oxygen ions are transferred to the anode support 110 through the electrolyte membrane 120.

The first current collecting member 130, which is a member surrounding the outer surface of cathode 112 to collect electricity energy, may have, for example, a mesh shape, a pelt shape, or the like surrounding the outer surface of the cathode 112 using a conductive wire. Here, since the first current collecting member 130 is oxidized with relation to the cathode 112 inside thereof, it is preferable to be subjected to oxidation-resistance coating treatment in order to prevent oxidization thereof.

The second current collecting member 140, which is a current member having a bimetal structure in which it is engaged with the outer peripheral surface of the first current collecting member 130, prevents a contact between the cathode 112 and the first current collecting member 130 from being decreased due to a gap therebetween at a high operating temperature of the fuel cell.

That is, the second current collecting member 140 has a bimetal structure in which two metal plates having different thermal expansion coefficients are bonded to each other in order to solve the problem of the decrease in contact and the increase in contact resistance between the first current collecting member 130 and the cathode 112 due to a thermal expansion at a high operating temperature of 700 to 900° C.

More specifically, as shown in FIG. 3, the second current collecting member 140, which is a member manufactured by bonding two kinds of the metal plate having different thermal expansion coefficients to each other, includes an inner metal plate 141 provided at an inner side thereof and engaged with the first current collecting member 130 and an outer metal plate 142 provided at an outer side thereof, the outer metal plate 142 having a thermal expansion coefficient higher than that of the inner metal plate 141.

The inner metal plate 141 may be formed of metal materials, such as Cr based alloy, Ferritic stainless steel, and the like, and the outer metal plate 142 may be formed of metal materials having a thermal expansion coefficient higher than that of the inner metal plate 141, such as Austenitic stainless steel, Fe—Ni—Cr based alloy, or the like.

The inner metal plate 141 and the outer plate 142 may be bonded to each other by, for example, cladding, welding, compressing, or the like and then be bent so as to have a C shape, thereby forming the second current collecting member 140.

The second current collecting member 140 having the structure as above, may be bent toward the inner metal plate 141 having a low thermal expansion coefficient due to a difference in the thermal expansion coefficients of the two metal plates, as the temperature increases.

Therefore, as the temperature increases, the second current collecting member 140 applies pressure to the first current collecting member 130, thereby preventing the gap between the first current collecting member 130 and the cathode 112 from occurring at a high operating temperature and maintaining a certain contact therebetween even at the high operating temperature.

In addition, as shown FIG. 2B, the second current collecting member 140 according to a preferred embodiment of the present invention may be selectively applied to a cathode support type fuel cell apparatus.

As shown FIG. 2B, the cathode support type fuel cell apparatus is different from the anode support type fuel cell apparatus that the cathode support 112 having a tubular shape receives an air from the manifold, and supports the electrolyte membrane 120 and the anode 110 which are sequentially stacked on the outer peripheral surface thereof.

The second current collecting member 140 according to the preferred embodiment of the present invention may also be applied to the cathode support type fuel cell apparatus, thereby preventing the gap between the first current collecting member 130 and the anode 110 from occurring at a high operating temperature and maintaining a certain contact therebetween even at the high operating temperature.

Therefore, according to the preferred embodiment of the present invention, the second current collecting member 140 may be provided in the cathode support type fuel cell apparatus as well as the anode support type fuel cell apparatus to thereby stably maintain a contact pressure with respect to the first current collecting member 130 and the cathode 112, or the first current colleting member 130 and the anode 110 even at a high temperature, thereby making it possible to improve current collection efficiency.

Hereinafter, a fuel cell apparatus having a bimetal current collecting member according to another preferred embodiment of the present invention will be described with reference to FIGS. 4 to 6.

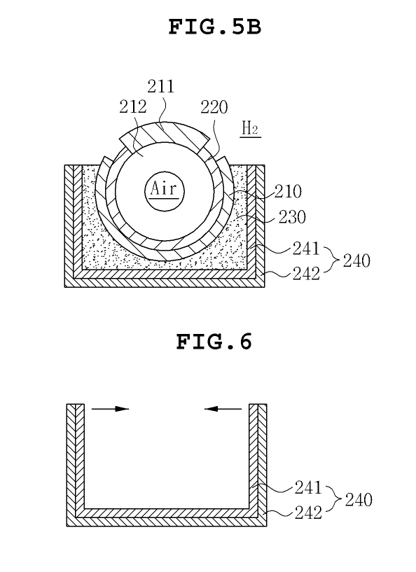

FIG. 4 is a side view showing an anode support type fuel cell apparatus with a bimetal current collecting member according to another preferred embodiment of the present invention, FIG. 5A is a cross-sectional view taken along line II-II′ of FIG. 1, FIG. 5B is a cross-sectional view showing a cathode support type fuel cell apparatus with a bimetal current collecting member according to another preferred embodiment of the present invention, and FIG. 6 is a cross-sectional view showing a bimetal current collecting member according to the another preferred embodiment of the present invention.

The fuel cell apparatus 200 according to another preferred embodiment of the present invention has a structure similar to that of the fuel cell apparatus 100 according to one preferred embodiment of the present invention and is different therefrom only in first and second current collecting members 230 and 240. Therefore, a description of the same structure between the fuel cell apparatus 200 according to another preferred embodiment of the present invention and the fuel cell apparatus 100 according to one preferred embodiment of the present invention will be omitted.

In the fuel cell apparatus 200 according to another preferred embodiment of the present invention, the first current collecting member 230 is a planar member having electric conductivity and porosity by using a metal foam, a metal fiber, or the like, and a groove provided into the upper surface thereof, the groove engaged with the cathode 212.

In addition, since the first current collecting member 230 has porosity, it may efficiently supply an air (oxygen) to the cathode 212. However, since the first current collecting member 230 has an oxidation atmosphere produced therein, it may be subjected to an oxidation resistance coating treatment in order to prevent the first current collecting member 230 from being oxidized.

The second current collecting member 240, which is a bimetal current collecting member having a cross section that is bent so as to have a “c” shape and engaged with the first current collecting member 230 having porosity, applies pressure to the first current collecting member 230 at a high operating temperature to prevent a contact between the cathode 212 and the first current collecting member 230 from being decreased due to a gap therebetween.

More specifically, the second current collecting member 240 is provided in a bent cross-section including an inner metal plate 241 engaged with an outer surface of the first current collecting member 230 and an outer metal plate 242 provided at an outer surface thereof and having a thermal expansion coefficient higher than that of the inner metal plate 241, as shown in FIG. 6.

The second current collecting member 240 may include the inner metal plate 241 formed of the metal materials such as chromium based alloy, Ferritic stainless steel, or the like, and the outer metal plate 242 formed of the metal materials such as Austenitic stainless steel, Fe—Ni—Cr based alloy, or the like.

By the bimetal structure, the second current collecting member 240 is bent toward the inner metal plate 241 having a low thermal expansion coefficient due to a difference in the thermal expansion coefficient of the two metal plates, as temperature increases, as shown in FIG. 6.

Therefore, the second current collecting member 240 applies pressure to the first current collecting member 230 having porosity at a high operating temperature to stably maintain a contact between the cathode 212 and the first current collecting member 230, thereby improving current collection efficiency.

In addition, as shown FIG. 5B, the second current collecting member 240 according to another preferred embodiment of the present invention may be selectively applied to a cathode support type fuel cell apparatus.

As shown FIG. 5B, the cathode support type fuel cell apparatus with a bimetal current collecting member according to another preferred embodiment of the present invention is different from an anode support type fuel cell in view of a structure including the cathode support 212 having a tubular shape, and the electrolyte membrane 220 and the anode 210 which are sequentially stacked on the outer peripheral surface of the cathode support 212.

The second current collecting member 240 according to the another preferred embodiment of the present invention may also be applied to the cathode support type fuel cell apparatus, thereby preventing the gap between the first current collecting member 230 and the anode 210 from being occurring at a high operating temperature and maintaining a certain contact therebetween even at the high operating temperature.

Therefore, in the present invention, the second current collecting member having various types of bimetal structures may be provided in the cathode support type fuel cell apparatus as well as the anode support type fuel cell apparatus, to stably maintain an electrical contact pressure even at a high temperature, thereby making it possible to improve current collection efficiency.

According to the preferred embodiments of the present invention, the fuel cell oxide apparatus includes the second current collecting member having a bimetal structure to stably maintain a contact between the first current collecting member and the second electrode even at a high operating temperature, thereby making it possible to improve current collection efficiency.

Although the spirit of the present invention was described in detail with reference to the preferred embodiments, it should be understood that the preferred embodiments are provided to explain, but do not limit the spirit of the present invention.

Also, it is to be understood that various changes and modifications within the technical scope of the present invention are made by a person having ordinary skill in the art to which this invention pertains.

What is claimed is:

1. A bimetal current collecting member comprising:
an inner metal plate engaged with the current collecting member surrounding an outer surface of a fuel cell; and
an outer metal plate having a thermal expansion coefficient higher than that of the inner metal plate and provided on an outer surface of the inner metal plate.

2. The bimetal current collecting member as set forth in claim 1, wherein the inner metal plate has a polygonal cross section according to an appearance of the current collecting member.

3. The bimetal current collecting member as set forth in claim 1, wherein the current collecting member is formed of a mesh or a pelt, and
the inner metal plate has a C-shaped cross section in which it surrounds the current collecting member.

4. The bimetal current collecting member as set forth in claim 1, wherein the current collecting member is a porous member formed of a metal foam or a metal fiber, and
the inner metal plate has a bent cross section in which it surrounds the current collecting member.

5. The bimetal current collecting member as set forth in claim 1, wherein the inner metal plate is formed of Cr based alloy or Ferritic stainless steel, and
the outer metal plate is formed of Austenitic stainless steel or Fe—Ni—Cr based alloy.

6. A fuel cell apparatus comprising:
a first electrode support having a tubular shape;
an interconnector connected to one side of the first electrode support;
an electrolyte membrane surrounding the interconnector and covering an outer surface of the first electrode support;
a second electrode formed at the outer surface of the electrolyte membrane while being spaced apart from the interconnector;
a first current collecting member surrounding an outer surface of the second electrode; and
a second current collecting member engaged with an outer surface of the first current collecting member and having a bimetal structure.

7. The fuel cell apparatus as set forth in claim 6, wherein the first electrode support is an anode support, and the second electrode is a cathode.

8. The fuel cell apparatus as set forth in claim 6, wherein the first electrode structure is a cathode support, and the second electrode is an anode.

9. The fuel cell apparatus as set forth in claim 6, wherein the second current collecting member includes an inner metal plate engaged with an outer surface of the first current collecting member; and
an outer metal plate having a thermal expansion coefficient higher than that of the inner metal plate and provided on the outer surface of the inner metal plate.

10. The fuel cell apparatus as set forth in claim 6, wherein the first current collecting member is formed of a mesh or a pelt, and the inner metal plate has a polygonal cross section in which it surrounds the current collecting member.

11. The fuel cell apparatus as set forth in claim 6, wherein the first current collecting member is a porous member formed by using a metal foam or a metal fiber, and the inner metal plate has a bent cross section in which it surrounds the current collecting member.

12. The fuel cell apparatus as set forth in claim 9, wherein the inner metal plate is a planar member formed of Cr based alloy or Ferritic stainless steel, and
the outer metal plate is a planar member formed of Austenitic stainless steel or Fe—Ni—Cr based alloy.

13. The fuel cell apparatus as set forth in claim 9, wherein the inner metal plate and the outer metal plate are bonded to each other by any one of cladding, welding and compressing methods.

14. The fuel cell apparatus as set forth in claim 6, wherein the first current collecting member is subjected to oxidation-resistance coating treatment in order to prevent oxidization thereof.
